(19) United States
(12) Patent Application Publication
(10) Pub. No.: US 2012/0074687 A1
(43) Pub. Date: Mar. 29, 2012

(54) PIPE FITTING APPARATUS

(76) Inventor: JAMES D. MITCHELL, Hermosa Beach, CA (US)

(21) Appl. No.: 12/888,692

(22) Filed: Sep. 23, 2010

(51) Int. Cl. F16L 43/00; B21D 31/00

(52) U.S. Cl. 285/179; 72/324

(57) ABSTRACT

The present invention is an improvement in conventional street elbow pipe design that allows for the street elbow pipe to be easily installed, removed, maintained, adjusted and handled without damage to the street elbow pipe itself or injury to a person performing work on the street elbow pipe. The street elbow pipe includes male and female fitting portions and a nut section disposed around at least one of the male and female fitting portions with a graspable surface area formed on the nut section.

### CROSS REFERENCE TO RELATED PATENT APPLICATIONS

Not applicable.

### STATEMENT REGARDING FEDERALLY-SPONSORED RESEARCH OR DEVELOPMENT

Not applicable.

### BACKGROUND OF THE INVENTION

The present invention relates generally to a pipe fitting apparatus. Specifically, the present invention relates to an improvement to conventional street elbow pipe design having an elongated portion and a nut section allowing a user to easily install, remove, maintain, adjust, and otherwise handle the street elbow pipe.

Street elbow pipes are sections of pipe configured to fit or join other pieces of piping together. Existing, prior art street elbow pipes are difficult to install, remove, maintain, adjust, and otherwise handle because of a small, smooth surface area between pipe ends and because of the angled nature of the conventional street elbow pipe. This small, smooth surface area prevents a user from grasping the street elbow pipe around the tubular pipe portion between ends to either hold or rotate the street elbow in place relative to a piece of pipe to which it is to be joined.

Users typically use a pipe wrench or similar tool to install, remove, maintain and adjust existing street elbow pipes, and must therefore grasp the street elbow pipe with a tool around the outside of one of the two open ends or with one portion on the inside of, and the other portion on the outside of, one of the two open ends. The force needed to manipulate the street elbow pipe results in damage to the open end of the street elbow pipe in the form of distortion of the shape of the pipe. Additionally, the threads on the open ends of the pipe are often stripped. Damaged pipes with either a distorted shape of the pipe or stripped threads are no longer useable, and therefore it is common to waste several street elbow pipes in industrial applications until it is properly installed, resulting in wasted parts and lost time. The tool used also often slips off of the open end, and users frequently suffer serious injury to the hands and arms as the skin comes in quick, sliding contact with the threaded portion of the open end of the street elbow pipe.

There is consequently a need in the art for a street elbow pipe, and generally a pipe fitting apparatus, that includes a way to easily grasp the pipe fitting apparatus for installation, removal, maintenance, and adjustment and to minimize the risk of damage to the pipe fitting apparatus or injury to the user.

### BRIEF SUMMARY OF THE INVENTION

Other features and advantages of the present invention will become apparent from the following description of the embodiments, taken together with the accompanying drawings, which illustrate, by way of example, the principles of the invention.

The present invention includes a street elbow pipe comprising a hollow tubular body having a male fitting portion and a female fitting portion, a bend disposed between the male fitting portion and the female fitting portion, and a substantially annular nut section elongating the hollow tubular body between the bend and an open threaded end of the male fitting portion and having a graspable surface formed thereon, the graspable surface having a width at least wide enough to accommodate grasping the hollow tubular body to handle the hollow tubular body relative to a first piece of pipe to be engaged with the open threaded end of the male portion and to hold the tubular body secure relative to a second piece of pipe to be engaged with an open threaded end of the female portion.

The present invention further includes a pipe fitting apparatus comprising a hollow tubular body having a female fitting portion and a male fitting portion elongated so as to be longer than the female fitting portion and angularly situated relative to the female portion along a point in the hollow tubular body, and a nut section disposed on the hollow tubular body on at least one of the male fitting portion and female fitting portion and having a surface formed thereon to accommodate grasping the hollow tubular body to join one piece of pipe with a second piece of pipe.

The present invention also includes a method of manufacturing a street elbow pipe comprising elongating a hollow tubular body having a male fitting portion, a female fitting portion, and a bend disposed between the male fitting portion and the female fitting portion along at least one of the male fitting portion and female fitting portion to create an area at least wide enough to accommodate a use of a tool to grasp the hollow tubular body, and machining a nut section along the elongated portion of the hollow tubular body and a surface suitable for grasping the hollow tubular body with the tool to handle the hollow tubular body so as to engage a first piece of pipe with an open threaded end of the male portion and to hold the hollow tubular body secure relative to a second piece of pipe to be engaged with an open threaded end of the female portion.

### BRIEF DESCRIPTION OF THE SEVERAL VIEWS OF THE DRAWINGS

FIG. 1A is a perspective view of a street elbow pipe according to one embodiment of the present invention;

FIG. 1B is a side view of a street elbow pipe according to the embodiment of the present invention of FIG. 1A;

FIG. 2A is another perspective view of a street elbow pipe according to the embodiment of the present invention of FIG. 1A;

FIG. 2B is a side view of a street elbow pipe according to the embodiment of the present invention shown in FIG. 2A;

FIG. 3A is a perspective view of a street elbow pipe according to another embodiment of the present invention;

FIG. 3B is another perspective view of a street elbow pipe according to the embodiment of the present invention of FIG. 3A;

FIG. 4A is a perspective view of a street elbow pipe according to another embodiment of the present invention;

FIG. 4B is a side view of a street elbow pipe according to the embodiment of the present invention of FIG. 4A;

FIG. 5A is a perspective view of a street elbow pipe according to another embodiment of the present invention;

FIG. 5B is another perspective view of a street elbow pipe according to the embodiment of the present invention of FIG. 5A;

FIG. 6A is a perspective view of a street elbow pipe according to another embodiment of the present invention;

FIG. 6B is another perspective view of a street elbow pipe according to the embodiment of the present invention of FIG. 6A;

FIG. 7 is another side view of a street elbow pipe according to the embodiment of the present invention of FIG. 1A and FIG. 2A;

FIG. 8 is another side view of a street elbow pipe according to the embodiment of the present invention of FIG. 1A and FIG. 2A;

FIG. 9 is another perspective view of a street elbow pipe according to the embodiment of the present invention of FIG. 1A and FIG. 2A;

FIG. 10 is yet another perspective view of a street elbow pipe according to the embodiment of the present invention of FIG. 1A and FIG. 2A;

FIG. 11 is yet another perspective view of a street elbow pipe according to the embodiment of the present invention of FIG. 1A and FIG. 2a; and

FIG. 12 is still another perspective view of a street elbow pipe according to the embodiment of the present invention of FIG. 1A and FIG. 2A.

### DETAILED DESCRIPTION OF THE INVENTION

In the following description of the present invention reference is made to the accompanying figures which form a part thereof, and in which is shown, by way of illustration, exemplary embodiments illustrating the principles of the present invention and how it may be practiced. It is to be understood that other embodiments may be utilized to practice the present invention and structural and functional changes may be made thereto without departing from the scope of the present invention.

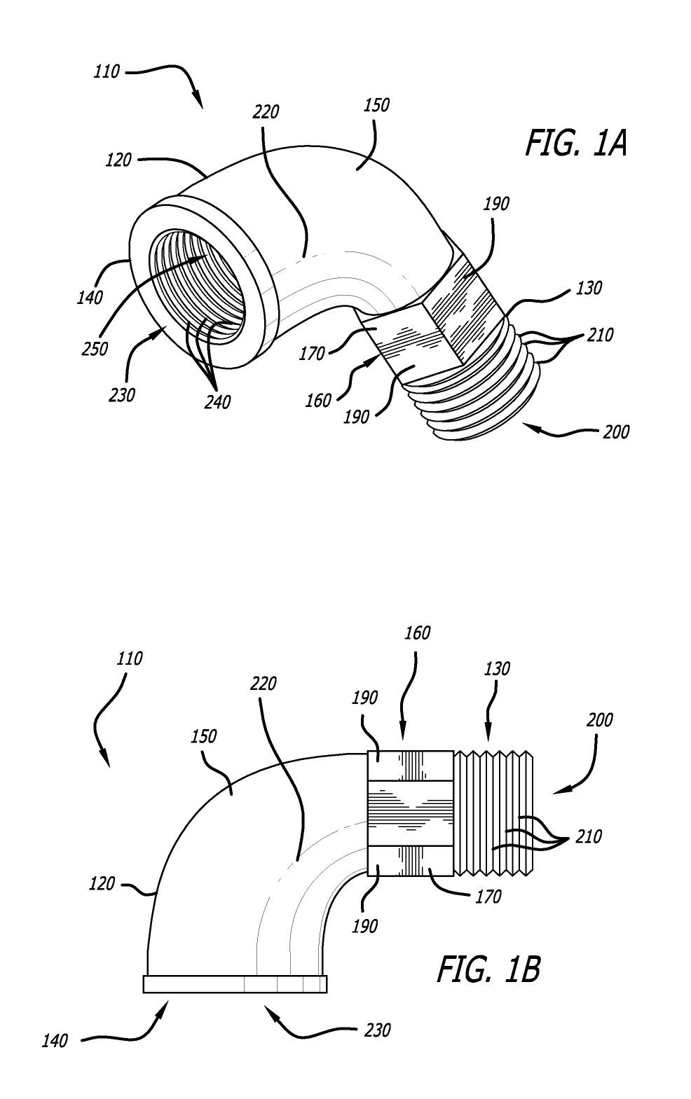

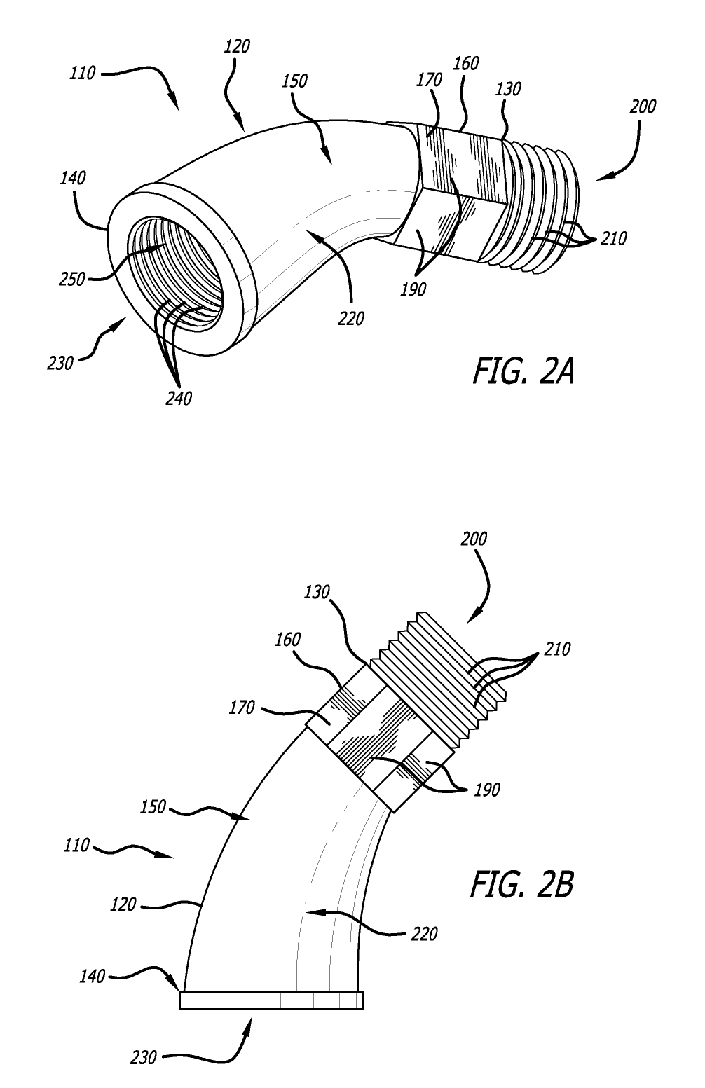

FIG. 1A and FIG. 2A are each a perspective view of a street elbow pipe 110 according to one embodiment of the present invention. The street elbow pipe 110 is a pipe fitting apparatus for use in various industrial applications, including for example movement of gas, water, air, oil and other liquids or gases through piping systems. The street elbow pipe 110 of the present invention includes a hollow, tubular body 120 that has a male fitting portion 130 and a female fitting portion 140. The male fitting portion 130 and the female fitting portion 140 are angularly situated relative to each other via a bend 150 that creates an angled configuration in the hollow, tubular body 120. FIG. 1B and FIG. 2B are each a side view of the street elbow pipe 110 according to this embodiment of the present invention.

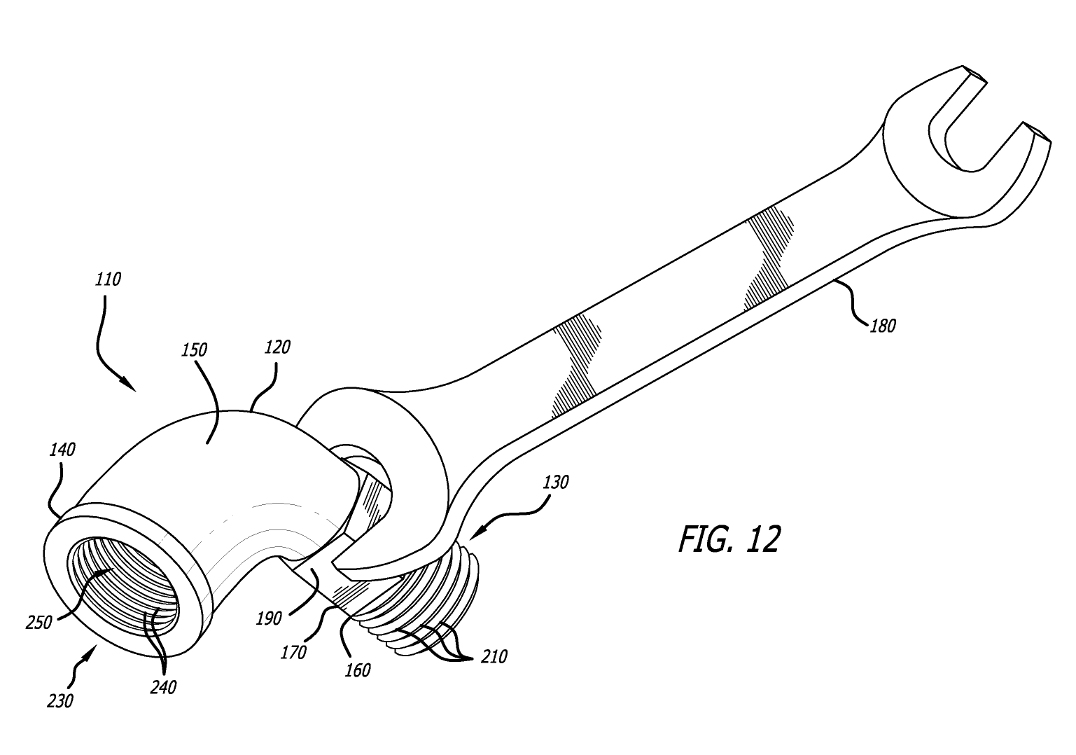

The street elbow pipe 110 includes a nut section 160. The nut section 160 is machined so that it is disposed on the hollow, tubular body 120 so as to be circularly or annularly formed thereon, either in a complete, partial, or substantial manner, so that it can take many different shapes and configurations as discussed herein. The nut section 160 includes a surface 170 that is configured so that the street elbow pipe 110 can be grasped by a tool 180 to install, remove, turn, and otherwise handle the hollow tubular body 120 and the street elbow pipe 110, as shown for example in FIG. 12. The surface 170 of the nut section 160 includes, in one embodiment, a plurality of sides 190 that form a poly-sided configuration so that the nut section 160 can be grasped by the tool 180, such as a standard wrench or a pipe wrench, as shown in FIG. 12. The present invention contemplates that any number of shapes can be therefore be formed, and that the surface 170 of the nut section 160 may be hexagonal (as shown in FIGS. 1-8) or any other polygonal shape, including but not limited to triangular, tetragonal, pentagonal, septagonal, octogonal, nonagonal, etc.

The nut section 160 is formed on the male fitting portion 130 as shown in FIG. 1A and FIG. 2A, at some point between the bend 150 in the hollow, tubular body 120 and an open, threaded end 200 of the male fitting portion 130. The male fitting portion 130 includes a plurality of male threads 210 disposed on an outside 220 of the hollow, tubular body 120 for engagement with threads of a separate female pipe portion. The female fitting portion 140 includes an open threaded end 230 that has a plurality of female threads 240 for accepting threads of a separate male pipe portion, the plurality of female threads 240 disposed on an inside 250 of the hollow, tubular body 120.

The nut section 160 may be formed on the male fitting portion 130, the female fitting portion 140, or on both. In one embodiment of the present invention, the nut section 160 is formed on the male fitting portion 130 as shown in FIG. 1A and FIG. 2A, at any point between the bend 150 in the hollow, tubular body 120 and the open, threaded end 200 of the male fitting portion 130. In this embodiment, the hollow, tubular body 120 is elongated by the presence of the nut section 160. The plurality of male threads 210 of the male fitting portion 130 may also include additional male threads 210 to make engagement with a separate female pipe portion easier for a user.

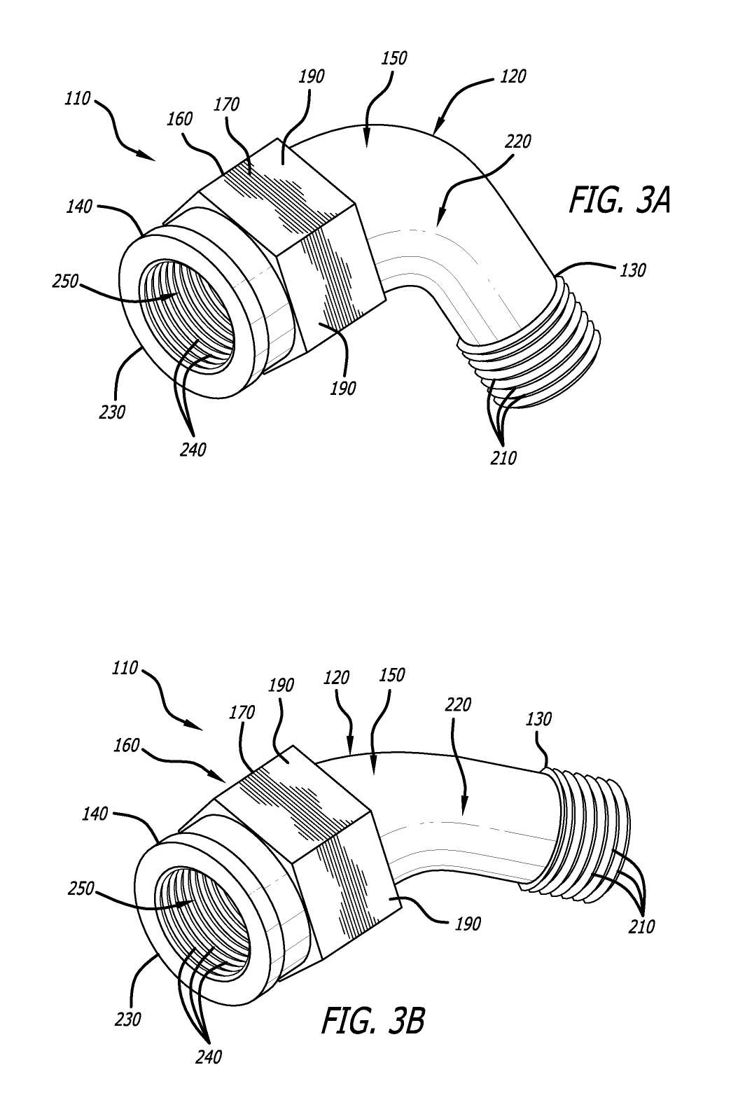

In another embodiment of the present invention, the nut section 160 is formed on the female fitting portion 140 as shown in FIG. 3A and FIG. 3B, at any point between the bend 150 in the hollow, tubular body 120 and the open, threaded end 230 of the female fitting portion 140. In this embodiment, the hollow, tubular body 120 is also elongated by the presence of the nut section 160. The plurality of female threads 240 of the female fitting portion 140 may also include additional female threads 240 to make acceptance with a separate male pipe portion easier for a user.

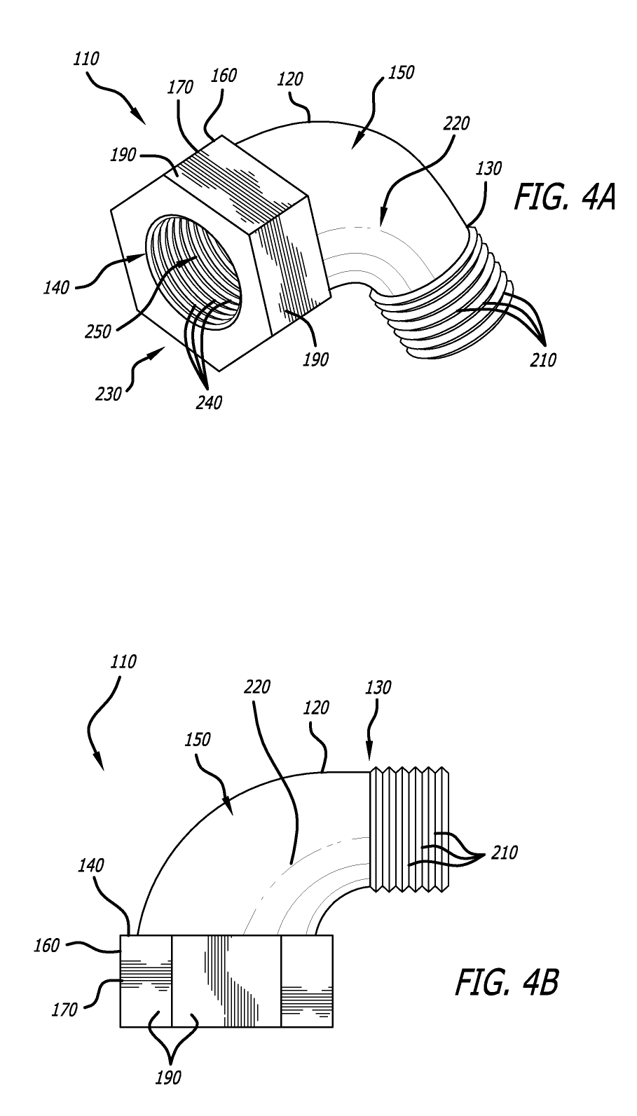

In still another embodiment of the present invention, the nut section 160 is formed on the female fitting portion 140 as shown in FIG. 4A and FIG. 4B, around the open, threaded end 230 of the female fitting portion 140. In this embodiment, the hollow, tubular body 120 is elongated by the presence of the nut section 160 around the open, threaded end 230 of the female fitting portion 140, and nut section 160 may be formed with a surface area of any size, as with all embodiments of the present invention. Similarly with the embodiment of FIG. 3A and FIG. 3B, the plurality of female threads 240 of the female fitting portion 140 may also include additional female threads 240 when the hollow, tubular body 120 is elongated to make acceptance with a separate male pipe portion easier for a user.

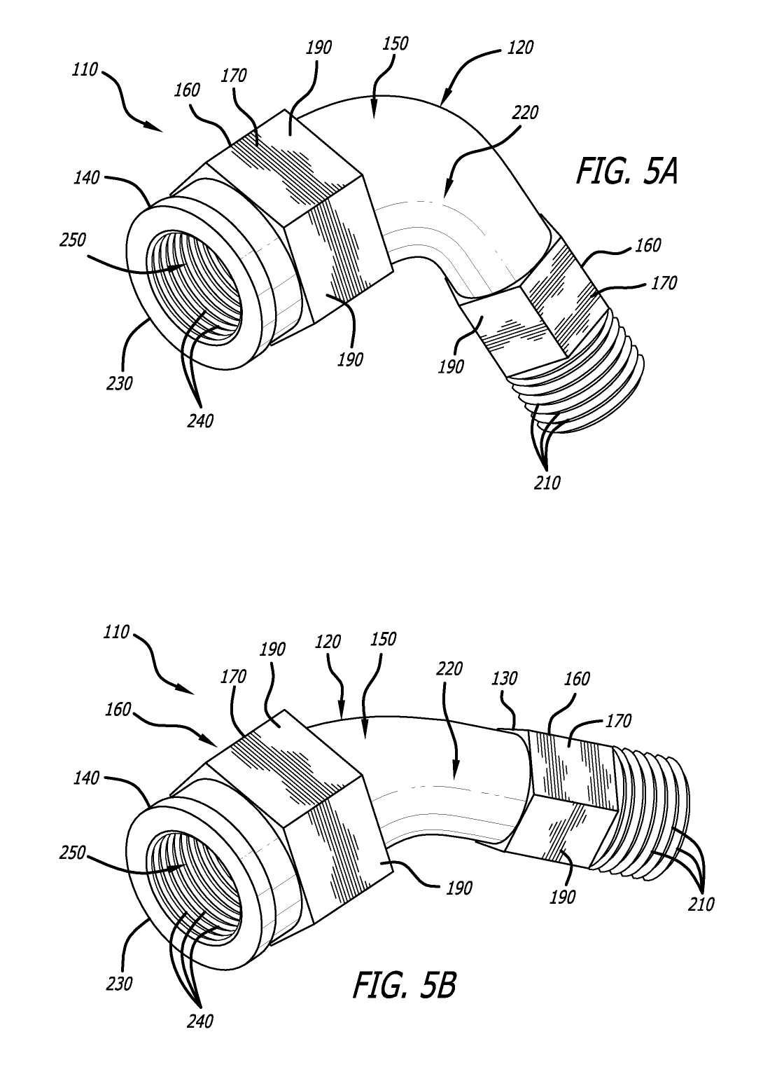

In yet another embodiment of the present invention, one nut section 160 is formed on the male fitting portion 130, and another nut section 160 is formed on the female fitting portion 140, as shown in FIG. 5A and FIG. 5B. The nut section 160 on the male fitting portion 130 may be formed at any point between the bend 150 and open, threaded end 200 of the male fitting portion 130, and the nut section 160 on the female fitting portion 140 may be formed at any point between the bend 150 and the open, threaded end 230 of the female fitting portion 140. In this embodiment, the hollow, tubular body 120 of the male fitting portion 130 and the hollow, tubular body 120 of the female fitting portion 140 are elongated respectively between the bend 150 and open threaded end 200, and the bend 150 and open, threaded end 230. It is understood that because the nut section 160 may be formed at any point, and may be formed at different points on the male fitting portion 130 and the female fitting portion 140, that the hollow, tubular body 120 may have the same or different lengths between the bend 150 and open, threaded end 200, and the bend 150 and open, threaded end 230.

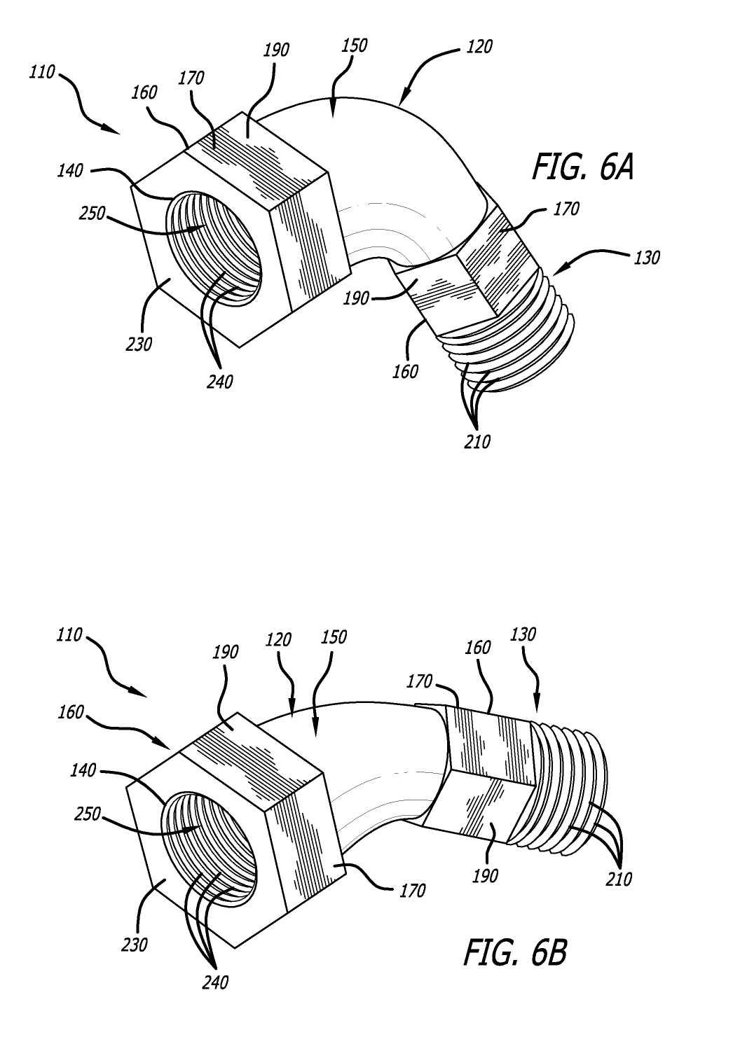

In another embodiment of the present invention, one nut section 160 is formed on the male fitting portion 130, and another nut section 160 is formed around the female fitting portion 140, as shown in FIG. 6A and FIG. 6B. The nut section 160 on the male fitting portion 130 may be formed at any point between the bend 150 and open, threaded end 200 of the male fitting portion 130, and the nut section 160 on the female fitting portion 140 is formed around the open, threaded end 230 of the female fitting portion 140. In this embodiment, the hollow, tubular body 120 of the male fitting portion 130 and the hollow, tubular body 120 of the female fitting portion 140 are elongated respectively between the bend 150 and open threaded end 200, and the bend 150 and open, threaded end 230. It is understood that because the nut section 160 may be formed at any point, and may be formed at different points on the male fitting portion 130, that the hollow, tubular body 120 may have the same or different lengths between the bend 150 and open, threaded end 200, and the bend 150 and open, threaded end 230.

It is further understood, and contemplated within the scope of the present invention, that the nut section 160 is machined so that it is disposed on the hollow, tubular body 120 independent of any consideration as to its placement. Accordingly, as with the embodiments of FIG. 1A and FIG. 2A, the nut section 160 may be machined so as to be circularly or annularly formed on the hollow, tubular body 120, regardless of whether it is machined on the male fitting portion 130, on the female fitting portion 140, or both, or formed around the open, threaded end 230 of the female fitting portion 140. The nut section 160 may be formed circularly or annularly either in a complete, partial, or substantial manner, so that it can take many different shapes and configurations as discussed herein.

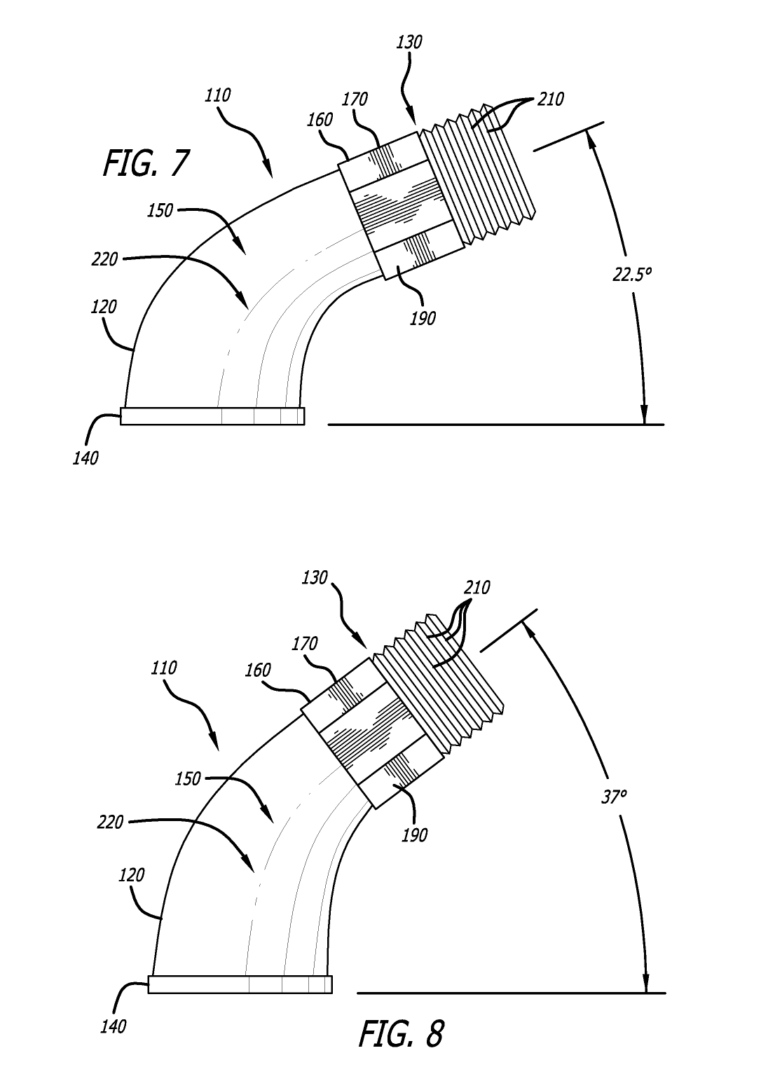

FIG. 7 and FIG. 8 are side views of a street elbow pipe 110 according to the embodiment of FIG. 1A and FIG. 2A. Street elbow pipes 110 are commonly machined in a 90° angled configuration, but may also be commonly machined in 45°, 37°, and 22.5° angles, or any other angle, and therefore the present invention contemplates that the bend 150 in the hollow, tubular body 120, regardless of the embodiment disclosed herein, may form any angle between the male fitting portion 130 and the female fitting portion 140. FIG. 7 is a street elbow pipe 110 shown with an angled configuration of 22.5°, and FIG. 8 is a street elbow pipe 110 shown with an angled configuration of 37°. It is therefore understood that different angles are applicable to all embodiments of the Figures in this application.

Regardless of the configuration of formation of the nut section 160 and the angle, the street elbow pipe 110 of the present invention is configured so that a person using the tool 180 can easily grasp the hollow, tubular body 120 along the surface 170 of the nut section 160 to either hold the street elbow pipe 110 secure while connecting the open, threaded end 200 of the male fitting portion 130 to a separate female pipe portion, or to hold the street elbow pipe 110 secure while connecting the open, threaded end 230 of the female fitting portion 140 to a separate male pipe portion, or both. The person using the tool 180 may also grasp the hollow, tubular body 120 along the surface 170 of the nut section 160 to install, remove, maintain, adjust, tighten, or loosen the street elbow pipe 110 relative to any other piece of equipment on which the street elbow pipe 110 is to be applied. Therefore, the street elbow pipe 110 according to the present invention prevents deformation of the open, threaded ends 200 and 230 in conventional, prior art street elbow pipes by obviating the need to grasp the street elbow pipe 110 around the open threaded ends, around the bend 150, or around the hollow, tubular body 120. By providing a place on the hollow, tubular body 120 of the street elbow pipe 110 to grasp it, the present invention enhances safety to the user when handling a street elbow pipe 110 by minimizing the risk of slippage and consequently injury to one's arms or hands.

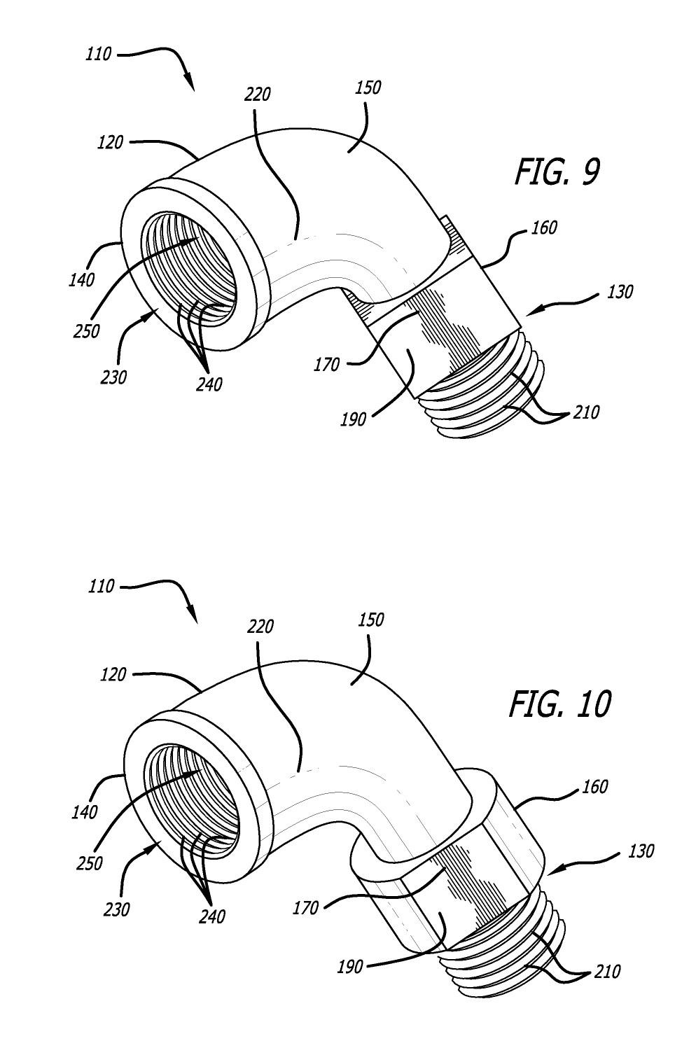

FIG. 9 is another perspective view of the street elbow pipe 110 of FIG. 1. As noted above, the present invention contemplates in one embodiment that the surface 170 of the nut section 160 may be multi-sided, and further that any number of sides may be present. Different shapes can be therefore be formed on the surface 170, so that the surface 170 may be hexagonal or any other polygonal shape, including but not limited to triangular, tetragonal, pentagonal, septagonal, octogonal, nonagonal, etc. Accordingly, FIG. 9 is a view of the street elbow pipe 110 where the surface 170 of the nut section 160 is square in shape. FIG. 10 is yet another view of the street elbow pipe 110 according to this embodiment, in which the surface 170 of the nut section 160 is formed with at least one flat or substantially flat side and two rounded sides. Such embodiments demonstrate that a user can utilize any type of wrench to easily handle the hollow, tubular body 120 of the street elbow pipe 110, including but not limited to both standard wrenches and pipe wrenches, as shown in FIG. 12. In the embodiment of FIG. 10, the multi-sided surface 170 may be further machined to include a slight depression in the at least one substantially flat side to allow for further security in using a wrench in tight spaces by minimizing the risk of slippage and stripping of the surface 170 of the nut section 160.

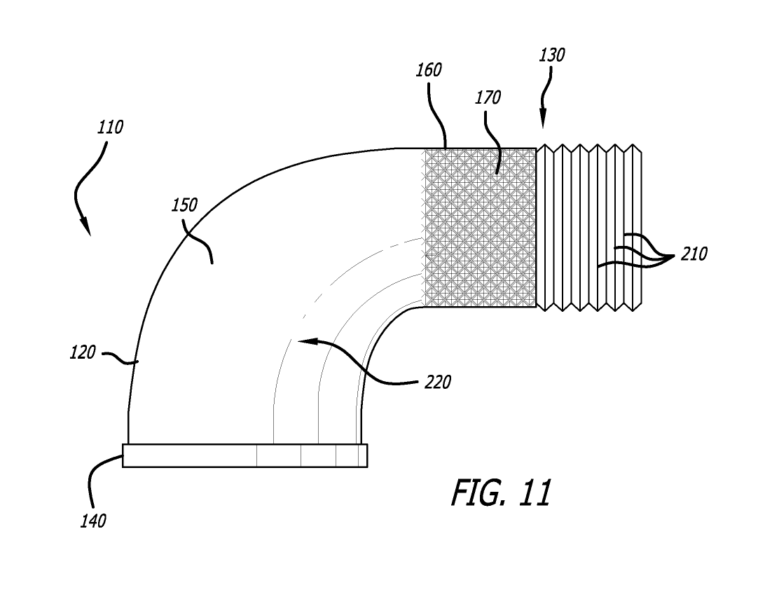

FIG. 11 is a further perspective view of the street elbow pipe 110 of FIG. 1 in an embodiment in which the multi-sided surface 170 of the nut section 160 is shown having many different facets so as to take the shape of small peaks and valleys, such as diamonds, in a knurled configuration. As with other views of the multi-sided surface 170 herein, the knurled configuration of FIG. 11 indicates a user has enhanced ability to grasp and safely handle the street elbow pipe 110 with a rough surface area.

FIG. 12 is a perspective view of the street elbow pipe 110 according the present invention in which a tool 180, in this instance a standard wrench, is being applied to the surface 170 of the street elbow pipe 110 to handle the street elbow pipe 110.

It is to be understood that other embodiments may be utilized and structural and functional changes may be made without departing from the scope of the present invention. The foregoing descriptions of embodiments of the present invention have been presented for the purposes of illustration and description. It is not intended to be exhaustive or to limit the invention to the precise forms disclosed. Accordingly, many modifications and variations are possible in light of the above teachings. For example, the knurled surface shown in FIG. 11 may be multi-sided with any number of sides as with other embodiments of the present invention, and may further include a slight depression in at least one of the sides as shown in the embodiment of FIG. 10. It is therefore intended that the scope of the invention be limited not by this detailed description.

1. A street elbow pipe comprising:
a hollow tubular body having a male fitting portion and a female fitting portion;
a bend disposed between the male fitting portion and the female fitting portion; and
a substantially annular nut section elongating the hollow tubular body between the bend and an open threaded end of the male fitting portion and having a graspable surface formed thereon, the graspable surface having a width at least wide enough to accommodate grasping the hollow tubular body to handle the hollow tubular body relative to a first piece of pipe to be engaged with the open threaded end of the male portion and to hold the tubular body secure relative to a second piece of pipe to be engaged with an open threaded end of the female portion.

2. The street elbow pipe of claim 1, wherein the graspable surface is multi-sided.

3. The street elbow pipe of claim 1, wherein the graspable surface has a hexagonal shape.

4. The street elbow pipe of claim 1, wherein the graspable surface is knurled.

5. The street elbow pipe of claim 1, wherein the bend disposed between the male fitting portion and the female fitting portion creates an angle between the male fitting portion and the female fitting portion.

6. The street elbow pipe of claim 1, further comprising a second substantially annular nut section elongating the hollow tubular body between the bend and the open threaded end of the female fitting portion.

7. The street elbow pipe of claim 5, wherein the second substantially annular nut section has a graspable surface having a width at least wide enough to accommodate grasping the hollow tubular body.

8. A pipe fitting apparatus comprising:
a hollow tubular body having a female fitting portion and a male fitting portion elongated so as to be longer than the female fitting portion and angularly situated relative to the female portion along a point in the hollow tubular body; and
a nut section disposed on the hollow tubular body on at least one of the male fitting portion and female fitting portion and having a surface formed thereon to accommodate grasping the hollow tubular body to join one piece of pipe with a second piece of pipe.

9. The pipe fitting apparatus of claim 8, wherein the surface is a multi-sided tool-grasping surface.

10. The pipe fitting apparatus of claim 8, wherein the surface is a tool-grasping surface having a hexagonal shape.

11. The pipe fitting apparatus of claim 8, wherein the surface is a knurled tool-grasping surface.

12. The pipe fitting apparatus of claim 8, wherein the nut section is disposed on the hollow tubular body on the male fitting portion so that the male fitting portion is angularly situated relative to the female fitting portion along a point in the hollow tubular body nearer to an open end of the female fitting portion than to an open end of the male fitting portion.

13. The pipe fitting apparatus of claim 8, wherein the nut section is disposed on the hollow tubular body on the female fitting portion so that the male fitting portion is angularly situated relative to the female fitting portion along a point in the hollow tubular body nearer to an open end of the male fitting portion than to an open end of the female fitting portion.

14. The pipe fitting apparatus of claim 8, wherein the nut section is a first nut section disposed on the hollow tubular body on the male fitting portion, and wherein a second nut section is disposed on the hollow tubular body on the female fitting portion.

15. The pipe fitting apparatus of claim 8, wherein the male fitting portion angularly situated relative to the female fitting portion forms a bend in the hollow tubular body with an angle of 90 degrees between the male fitting portion and the female fitting portion.

16. The pipe fitting apparatus of claim 8, wherein the male fitting portion angularly situated relative to the female fitting portion forms a bend in the hollow tubular body with an angle of less than 90 degrees between the male fitting portion and the female fitting portion.

17. A method of manufacturing a street elbow pipe comprising:
elongating a hollow tubular body having a male fitting portion, a female fitting portion, and a bend disposed between the male fitting portion and the female fitting portion along at least one of the male fitting portion and female fitting portion to create an area at least wide enough to accommodate a use of a tool to grasp the hollow tubular body; and
machining a nut section along the elongated portion of the hollow tubular body and a surface suitable for grasping the hollow tubular body with the tool to handle the hollow tubular body so as to engage a first piece of pipe with an open threaded end of the male portion and to hold the hollow tubular body secure relative to a second piece of pipe to be engaged with an open threaded end of the female portion.

18. The method of claim 17, wherein the elongating a hollow tubular body further comprises elongating the hollow tubular body along the male fitting portion and machining a first nut section along the hollow tubular body on the male fitting portion.

19. The method of claim 18, wherein the elongating a hollow tubular body further comprises elongating the hollow tubular body along the female fitting portion and machining a second nut section along the hollow tubular body on the female fitting portion.

20. The method of claim 17, wherein the elongating a hollow tubular body further comprises elongating the hollow tubular body along the female fitting portion and machining a first nut section along the hollow tubular body on the female fitting portion.

21. The method of claim 17, further comprising machining a plurality of additional threads on the open threaded end of the male fitting portion on an outside of the hollow tubular body.

22. The method of claim 17, further comprising machining a plurality of additional threads on the open threaded of the female fitting portion on an inside of the hollow tubular body.

23. The method of claim 17, wherein the machining a nut section along the elongated portion of the hollow tubular body and a surface further comprises machining a multi-sided surface.

24. The method of claim 17, wherein the machining a nut section along the elongated portion of the hollow tubular body and a surface further comprises machining a multi-sided surface having six sides to form a hexagonal shape.

25. The method of claim 17, wherein the machining a nut section along the elongated portion of the hollow tubular body and a surface further comprises machining a knurled surface.
